(19) United States
(12) Patent Application Publication
(10) Pub. No.: US 2023/0065042 A1
(43) Pub. Date: Mar. 2, 2023

(54) BLOCKCHAIN MARKETPLACE FOR DEBT CAPITAL

(71) Applicant: ROYAL BANK OF CANADA, Toronto (CA)

(72) Inventors: Tiffany LI, Vancouver (CA); Samuel WELLER, Toronto (CA); Arsh KOCHAR, Brampton (CA); Alifiyah HUSSAIN, Toronto (CA); Endri MANI, Toronto (CA); Alexander DOMENICK, Toronto (CA)

(21) Appl. No.: 17/887,797

(22) Filed: Aug. 15, 2022

Related U.S. Application Data
(60) Provisional application No. 63/237,685, filed on Aug. 27, 2021.

(51) Int. Cl. G06Q 40/04; G06Q 40/06

(52) U.S. Cl. CPC G06Q 40/04; G06Q 40/06

(57) ABSTRACT

A marketplace for trading bonds on the block chain includes a bond token smart contract that tokenizes the bond for buying/selling using a stablecoin. Each bond generates a corresponding marketplace smart contract. A whitelist smart contract is used to provide permissions for trading bonds on the block chain.

### RELATED APPLICATIONS

This application claims priority to U.S. Provisional application 63/237,685 filed Aug. 27, 2021 titled “BLOCKCHAIN MARKETPLACE FOR DEBT CAPITAL,” the entire contents of which are incorporated herein by reference in their entirety.

### TECHNICAL FIELD

The current disclosure relates to a marketplace for raising debt capital and in particular to a marketplace implemented on a blockchain.

### BACKGROUND

Raising debt capital is one of the main ways a corporation or government entity can fund projects or operations. One way to raise debt capital is through issuing of bonds. Bonds are an “I owe you” where an investor agrees to loan money to a company or government in exchange for a predetermined interest rate and duration. Bonds are the most common form of fixed-income securities which pays a fixed amount of interest income in the form of coupon payments.

Historically, the process of coupon payments was manual and not electronic. Investors would line up at the bank with their bond coupon slips to redeem interest payments. Today, the many aspects of the process are electronic or digitized however, it still largely involves manual steps across various layers of intermediaries. Various intermediaries are involved in the bond issuing and payment leading to multiple versions of the truth being stored and so providing ample room for error and friction across a bond's lifecycle. The process is typically a multi-step manual process of legacy systems that has a limited electronic audit trail requiring extensive cross-checking between intermediaries. The bond process typically has a long clearing cycle of 3+ days and 24/7 non-availability of systems leading to increased settlement risks and avoidable collateral costs. The data reconciliation and retention required for auditing can be costly.

Recently, bonds have been issued, and their coupons paid, on a blockchain, however they have been for single bonds and have not provided a framework that provides a marketplace for the trading of bonds on the blockchain.

### SUMMARY

A marketplace implemented on a blockchain for raising debt capital is desirable for alleviating typical pain points associated with current debt capital processes.

In accordance with the present disclosure, there is provided a method for use in issuing a bond comprising: adding an address of a verified bond issuer on a smart contract blockchain network to a whitelist smart contract (whitelist) executing on the smart contract blockchain network, the whitelist smart contract providing permissions for issuing and buying bonds on the smart contract blockchain network; executing by the smart contract blockchain network a bond token smart contact for bond tokens, the bond tokens using a global stablecoin (stablecoin) defined in a global stablecoin smart contract as a currency, the bond token smart contract including functionality for: specifying a coupon payment schedule; paying coupon payments to blockchain addresses of respective bond token holders using the stablecoin, the coupon payments automatically paid according to the coupon payment schedule of the bond token; and paying final payments to blockchain addresses of respective bond token holders using the stablecoin, upon maturity of the bond; and executing by the smart contract blockchain network a marketplace smart contract for a bond marketplace, the marketplace smart contract including functionality for: creating bids for purchasing bond tokens by authorized entities on the whitelist, the purchase made using the stablecoin; creating offers for selling bond tokens by authorized entities on the whitelist, the sale made using the stablecoin; and matching bids to offers to buy/sell bond tokens and carrying out the matched bids/offers.

In accordance with a further embodiment of the method, the method further comprises: periodically calling by the smart contract blockchain network the functionality for paying coupon payments of the bond tokens.

In accordance with a further embodiment of the method, the functionality for paying coupon payments determines if a current block of the smart contract blockchain network is greater than or equal to a block specified in the coupon payment schedule.

In accordance with a further embodiment of the method, the functionality for paying coupon payments calls the functionality for paying the final coupon payment when the current block of the smart contract blockchain network is greater than or equal to a final payment block specified in the coupon payment schedule.

In accordance with a further embodiment of the method, the functionality for creating bids comprises functionality for transferring the bid amount to a staking address until a transactions occurs for the created bid, the created bid is cancelled or the created bid expires.

In accordance with a further embodiment of the method, the functionality for creating offers comprises functionality for transferring the offer size of tokens to a staking address until a transactions occurs for the created offer, the created offer is cancelled or the created offer expires.

In accordance with a further embodiment of the method, the method further comprises: deploying a global marketplace contract to the smart contract blockchain network, the global marketplace contract comprising functionality for tracking different bond marketplace smart contracts.

In accordance with the present disclosure there is further provided a non transitory computer readable medium storing instructions for execution on a smart contract blockchain network, the instructions providing: a whitelist smart contract providing permissions for entities for issuing, buying and selling bonds on the smart contract blockchain network; a bond token smart contact for bond tokens for execution on the smart contract blockchain network using a stablecoin, the bond tokens including functionality for: specifying a coupon payment schedule; paying coupon payments to blockchain addresses of respective bond token holders using the stablecoin, the coupon payments automatically paid according to the coupon payment schedule of the bond token; and paying final payments to blockchain addresses of respective bond token holders using the stablecoin, upon maturity of the bond; and a marketplace smart contract (marketplace) for execution on the smart contract blockchain network, the marketplace including functionality for: creating bids for purchasing bond tokens by authorized entities on the whitelist, the purchase made using the stablecoin; creating offers for selling bond tokens by authorized entities on the whitelist, the sale made using the stablecoin; and matching bids to offers to buy/sell bond tokens and carrying out the matched bids/offers.

In accordance with a further embodiment of the computer readable medium, the computer readable medium further comprises: a stablecoin contract providing a stablecoin as a currency for buying and selling bond tokens on the smart contract blockchain network

In accordance with a further embodiment of the computer readable medium, the computer readable medium further comprises: a bids smart contract for generating bids to purchase bond tokens; and an offers smart contract for generating offers to sell bond tokens.

In accordance with a further embodiment of the computer readable medium, the functionality for paying coupon payments determines if a current block of the blockchain network is greater than or equal to a block specified in the coupon payment schedule.

In accordance with a further embodiment of the computer readable medium, the functionality for paying coupon payments calls the functionality for paying the final coupon payment when the current block of the blockchain network is greater than or equal to a final payment block specified in the coupon payment schedule.

In accordance with a further embodiment of the computer readable medium, the functionality for creating bids comprises functionality for transferring the bid amount to a staking address until a transactions occurs for the created bid, the created bid is cancelled or the created bid expires.

In accordance with a further embodiment of the computer readable medium, the functionality for creating offers comprises functionality for transferring the offer size of tokens to a staking address until a transactions occurs for the created offer, the created offer is cancelled or the created offer expires.

In accordance with a further embodiment of the computer readable medium, the computer readable medium further comprises: a global marketplace contract to the smart contract blockchain network, the global marketplace contract comprising functionality for tracking different bond marketplace smart contracts.

In accordance with the present disclosure, there is further provided a computing device for use in issuing a bond comprising: a processor for executing instructions; and a memory storing instructions which when executed by the processor configure the computing device to perform a method comprising: accessing functionality executing on a smart contract blockchain network network to add an address on the smart contract blockchain network of a verified bond issuer to a whitelist smart contract (whitelist) executing on the smart contract blockchain network, the whitelist smart contract providing permissions for issuing and buying bonds on the smart contract blockchain network; deploying to the smart contract blockchain network a bond token smart contact for bond tokens, the bond tokens using a global stablecoin (stablecoin) defined in a global stablecoin smart contract as a currency, the bond token smart contract including functionality for: specifying a coupon payment schedule; paying coupon payments to blockchain addresses of respective bond token holders using the stablecoin, the coupon payments automatically paid according to the coupon payment schedule of the bond token; and paying final payments to blockchain addresses of respective bond token holders using the stablecoin, upon maturity of the bond; and deploying to the smart contract blockchain network a marketplace smart contract for a bond marketplace, the marketplace smart contract including functionality for: creating bids for purchasing bond tokens by authorized entities on the whitelist, the purchase made using the stablecoin; creating offers for selling bond tokens by authorized entities on the whitelist, the sale made using the stablecoin; and matching bids to offers to buy/sell bond tokens and carrying out the matched bids/offers.

In accordance with a further embodiment of the computing device, the method provided by the computing device further comprises deploying to the smart contract blockchain network a stablecoin contract providing a stablecoin as a currency for buying and selling bond tokens on the smart contract blockchain network

In accordance with a further embodiment of the computing device, the method provided by the deploying to the smart contract blockchain network: a bids smart contract for generating bids to purchase bond tokens; and an offers smart contract for generating offers to sell bond tokens.

In accordance with a further embodiment of the computing device, the functionality for paying coupon payments determines if a current block of the blockchain network is greater than or equal to a block specified in the coupon payment schedule.

In accordance with a further embodiment of the computing device, the functionality for paying coupon payments calls the functionality for paying the final coupon payment when the current block of the blockchain network is greater than or equal to a final payment block specified in the coupon payment schedule.

In accordance with a further embodiment of the computing device, the functionality for creating bids comprises functionality for transferring the bid amount to a staking address until a transactions occurs for the created bid, the created bid is cancelled or the created bid expires.

In accordance with a further embodiment of the computing device, the functionality for creating offers comprises functionality for transferring the offer size of tokens to a staking address until a transactions occurs for the created offer, the created offer is cancelled or the created offer expires.

In accordance with a further embodiment of the computing device, the method provided by the computing device further comprises deploying to the smart contract blockchain network a global marketplace contract comprising functionality for tracking different bond marketplace smart contracts.

### BRIEF DESCRIPTION OF THE DRAWINGS

In the accompanying drawings, which illustrate one or more example embodiments:

FIG. 1 depicts components of a smart contract blockchain capable of implementing a debt capital marketplace and user interface components for interacting with the debt capital marketplace on the blockchain;

FIG. 2 depicts a marketplace for debt capital on a blockchain and a system for interacting with the marketplace;

FIG. 3 depicts smart contract components that are implemented on a smart contract blockchain to provide a debt capital marketplace;

FIG. 4 depicts components of a bond token smart contract and a corresponding marketplace contract;

FIG. 5 depicts processes for purchasing and selling bonds as well as making coupon payments on a blockchain marketplace;

FIG. 6 depicts processes for creating offers for selling bonds and bids for purchasing them as well as completing the sale/purchase of bonds according to the offers and bids on the blockchain marketplace;

FIG. 7 depicts a method for issuing a bond on a smart contract blockchain;

FIG. 8 depicts a process flow for bond issuance with a general primary market;

FIG. 9 depicts a process flow for regular bond issuance;

FIG. 10 depicts a process flow for bond trading with staking;

FIG. 11 depicts a process flow for coupon payment for bonds;

FIG. 12 depicts a process flow for final repayment of a bond;

FIG. 13 depicts a process flow for cancelling a trade; and

FIG. 14 depicts a process flow for an expiring trade.

### DESCRIPTION

Smart contracts can be executed on a blockchain that provide a marketplace for debt capital instruments such as bonds. By implementing a marketplace on a blockchain as described below, it is possible for the issuance, buying, selling and payments of bonds and their coupons to be significantly automated. With the automation of payment and reconciliation processes through the smart contracts on the blockchain, settlement times can be reduced from T+3 days to T+0 days, that is settlement can be substantially instant. As described in further detail below, the marketplace may enforce permissions for entities interacting with the marketplace to ensure only authorized entities are able to issue and/or trade bonds, or other debt instruments. The smart contracts providing the bond market place can include business and legal logic programmed into them to eliminate settlement agents and related trust accounts. In addition to providing a nearly instant settlement process for bond transactions, the blockchain marketplace can also provide greater transparency into the transactions occurring in the marketplace since all transactions are stored on the blockchain. In addition to providing greater transparencies into the transactions occurring, the blockchain also has an immutable storage of the transactions thereby providing an audit trail of all transactions for regulators.

The systems, methods described herein provide an application that can use a permissioned instance of a smart contract blockchain, such as the Ethereum blockchain, unlocking the ability to automate payments and to achieve real-time settlement through smart contracts. The blockchain may be a private or public instance of the Ethereum blockchain or other blockchain technologies such as Hyperledger Fabric, Dragonchain, etc. The smart contracts executing on the blockchain provide a marketplace that connects and allows bond issuers, investors, underwriters, bookrunners, and regulators to seamlessly service all bond needs of issuance/settlement, coupon payments, and maturity repayment all in one place. Although described below with particular reference to bonds, it will be appreciated that the same marketplace may be used for the trading of other financial instruments.

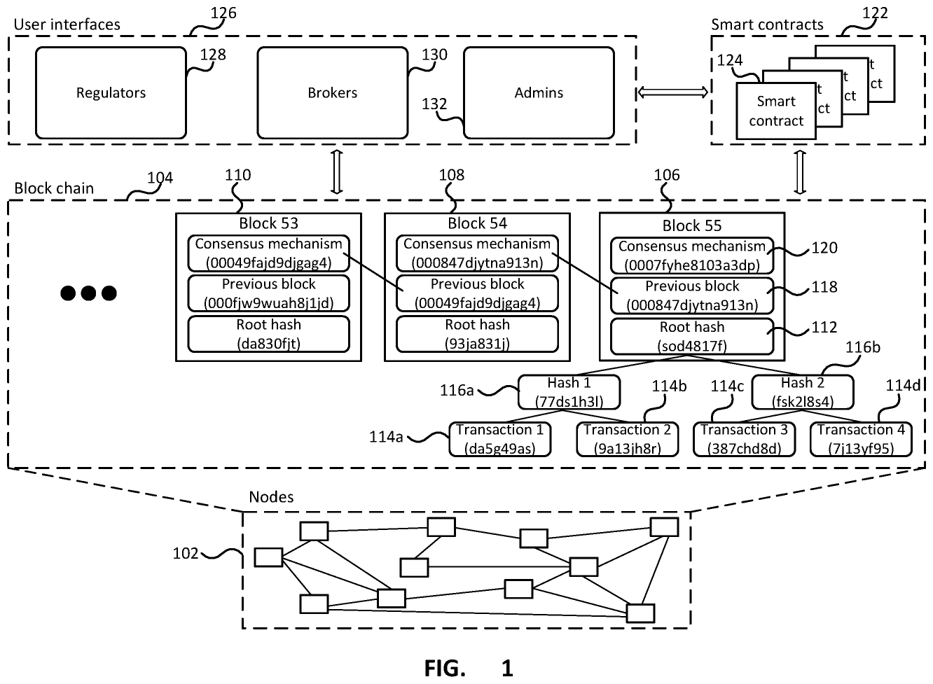

FIG. 1 depicts components of a smart contract blockchain capable of implementing the debt capital marketplace and user interface components for interacting with the debt capital marketplace on the blockchain. The blockchain 102 is provided by a plurality of nodes which are each computing devices capable of implementing the blockchain protocol. While there are different blockchains, the blockchain used for the bond marketplace is a smart contract blockchain that is able to store and execute smart contracts on a blockchain 104. As an example, the smart contract blockchain may be the Ethereum blockchain. In the Ethereum blockchain, all of the nodes of the blockchain network run the Ethereum virtual machine (EVM) and execute the same instructions. Each of the nodes receives transactions and attempts to add the transactions to the blockchain 104. The blockchain comprises a number of blocks 106, 108, 110 with each block linked to the previous block. Each block stores transactions 114a, 114b, 114c, 114d, or representations of the transactions which may include a cryptographic hash of the transaction. The transactions may be stored in the leaf nodes of a Merkle tree or hash tree. Pairs of the leaf nodes can be hashed and stored as another layer of the tree 116a, 116b. The Merkle tree 112, may be stored in a block 106 for storing the transactions. In addition to the transactions, the block may include a cryptographic hash representation of the previous block 118. The block includes a consensus mechanism 120, such as proof of work, which can be generated by concatenating the root hash, previous block pointer 119 and a nonce (not shown). The proof of work may be done by repeatedly changing a nonce value and taking the cryptographic hash until the hash value begins with a predetermined value. For example, the proof of work may require determining the nonce that will produce a hashed value beginning with four 0s. By changing the number of leading 0s, or the length of the predetermined value, the difficulty of the proof of work can be varied. Once the nonce value producing the predetermined value, such as ‘0000’, for the hash value, the block can be added to the blockchain. The proof of work hash value of a parent block may be used to link the next block. Since each block is linked using a cryptographic hash based on a previous block's hash and the current transactions, the blocks and transactions in the blockchain cannot be modified, or any attempt to modify blocks can be identified.

The above has described use of a cryptographic proof of work as the consensus mechanism for adding blocks to the blockchain. However, it is possible that other consensus mechanisms may be used, such as a proof of stake consensus mechanism. In proof of work mechanisms, many ‘miners’ compete to find the hashed value. All of the computing, and associated electricity, done by the miners that were not successful in finding the hashed value is wasted. In proof of stake mechanism ‘validators’ which are similar to miners pay an amount into the network, their ‘stake’ and one of the validators is selected at random with the probability based on the amount of stake the validator has. The selected validator may then generate the hashed value for the block, which does not require determining the nonce to prove the work, and add the block to the blockchain. The proof of stake consensus mechanism avoids the large amount of wasted computations performed by proof of work. It will be appreciated that the proof of work or proof of stake consensus mechanism may be used in the blockchain, or alternative consensus mechanisms could be used such as proof of capacity, proof of activity, proof of burn, etc.

The blockchain network can execute smart contracts 122 that provide various functionality including smart contracts that provide a bond marketplace. Each smart contract 124 is program code that runs on the blockchain. The smart contract is a collection of code providing the smart contract's function(s) and data providing the smart contract's state. Each smart contract is a type of blockchain account and resides at a specific address on the blockchain. Smart contracts may have a balance and can send transactions over the blockchain network. However, rather than being controlled by a user, smart contracts are deployed to the network and executed by the blockchain nodes as programmed. User accounts can interact with a smart contract by submitting transactions that execute a function defined by the smart contract. Smart contracts can define rules, like a regular contract, and automatically enforce them via the code. As described further below, a number of different smart contracts can be provided that tokenize bonds and provide a bond marketplace on the blockchain.

In addition to the smart contracts 122 and blockchain 104 implemented on the blockchain nodes 102, the marketplace may also include user interface components 126 that are implemented off of the blockchain and can provide an interface to the smart contracts and blockchain. The user interfaces may be provided by one or more computing devices (not shown) and include functionality for regulators 128, such as reviewing transactions for auditing purposes, functionality for brokers 130 for issuing and trading bonds as well as functionality for administrators 132 which may include functionality for verifying and adding users to the system.

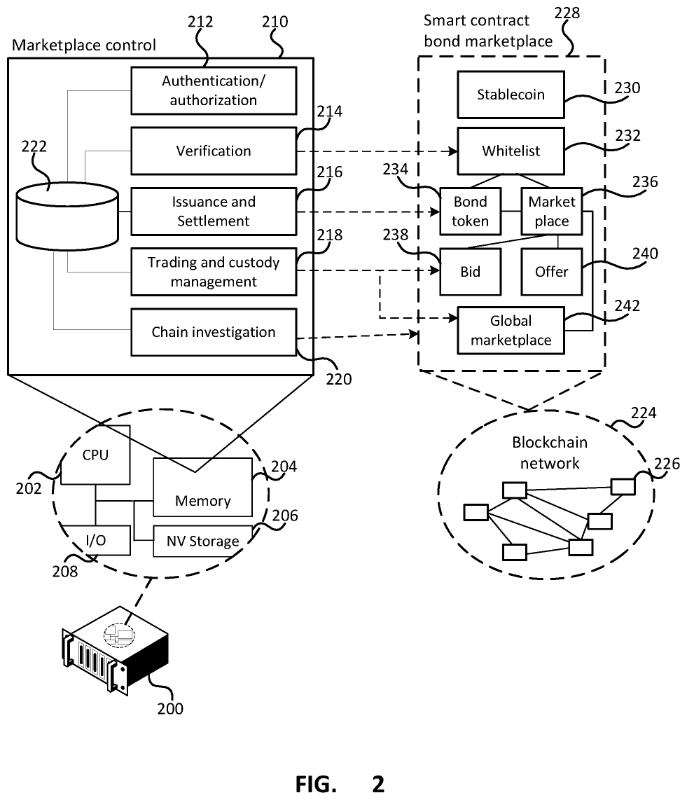

FIG. 2 depicts a marketplace for debt capital on a blockchain and a system for interacting with the marketplace. The system for interacting with the marketplace is depicted as a server 200, however it will be appreciated that similar functionality may be provided by one or more interacting servers, which may be communicatively coupled together by one or more communication networks such as the Internet. The server 200 comprises a processor 202 that controls the server's 200 overall operation by executing instructions. The processor 202 is communicatively coupled to and controls several subsystems. These subsystems include one or more memory units 204, such as random access memory (“RAM”) 204, which store computer program code for execution at runtime by the processor 202; non-volatile storage 206, which stores the computer program code executed by the RAM 204 at runtime; comprise input/output (I/O) interfaces 208 that allow additional components to be coupled to the system, either internally or externally. For example, the additional components may comprise, for example, any one or more of a keyboard, mouse, touch screen, voice control; a display controller, which is communicatively coupled to and controls a display; and a network interface, which facilitates network communications with a wide area network and other computing devices. The non-volatile storage 206 has stored on it computer program code that is loaded into the RAM 204 at runtime and that is executable by the processor 202. When the computer program code is executed by the processor 202, the processor 202 causes the server 200 to implement various functionality, including for example, marketplace control functionality 210.

The marketplace control functionality 210 provides for the control of and the bond marketplace on the blockchain. The marketplace control functionality may provide various different user interfaces for allowing different users to interface with the marketplace control functionality and so the bond marketplace. For example, a web-based user interface may be provided, or a mobile application or ‘app’. Further, the particular user interface provided may differ depending upon the type of user. For example, the user interface presented to company issuing a bond may differ from the user interface presented to an auditor or regulator.

The marketplace control functionality 210 may include for example authentication and authorization functionality 212 that allows different users of the system to be authenticated and authorized to access the marketplace. The functionality 212 may also add new users to the system for subsequent authentication/authorization. In addition to the authentication/authorization functionality 212, the marketplace control functionality 210 may further comprise verification functionality 214 that verifies an entity, such as a company, broker, auditor, etc. for participating in the bond marketplace. For example, depending upon jurisdictions, “know your client” (KYC) information may be collected and verified. Further verification may be made for traders to ensure their ability to trade bonds, or for auditors/regulators. Once the different entities are verified, they or more particularly an associated identifier (ID) may be added to a whitelist smart contract that is used to provide permissions for entities using the marketplace.

The marketplace control functionality 210 further includes issuance and settlement functionality 216 that allows verified entities, that have been authenticated and authorized to issue bonds. The functionality may receive bond information, including for example company information such as the company name and whitelist address and bond parameters such as the bond type and bond conditions. Once all of the information is provided, the bond may be issued and the appropriate smart contracts generated and deployed to the blockchain. The as described further below, the generated smart contracts can tokenize the bond and create a marketplace for trading the bond tokens. The deployed smart contracts can automate the coupon payments from the issuer to the bond holders as well as the final payments and archiving of the bond transactions.

The marketplace control functionality 210 further includes trading and custody management functionality 218 that allows a user to manage their wallet, including adding funds to the wallet and exchanging fiat currency for stablecoins used by the marketplace. The trading and custody management functionality 218 further includes functionality for viewing the available marketplaces for trading bond tokens. The functionality may access the blockchain and possibly information stored off the blockchain in order to display details about the bond. The trading and custody management functionality 218 may also provide functionality for trading bonds on the blockchain.

The marketplace control functionality 210 further includes chain investigation functionality 220. The chain investigation functionality 220 may be used by investors and/or investors to view the transactions that have occurred on the blockchain marketplace. The chain investigation functionality may allow auditors, regulators or other entities that have been whitelisted to monitor the marketplace blockchain network to view and verify transactions at any time.

The marketplace control functionality 210 described above allows users to interact with a bond marketplace implemented on a smart contract blockchain, including creating and issuing bonds on the blockchain, buying/selling bonds in the marketplace and auditing the transactions occurring on the marketplace. The functionality described above may deploy smart contracts to the blockchain, interact with smart contracts deployed on the blockchain as well access information stored on the blockchain. Additionally, the marketplace control functionality 210 may also store and access information in one or more databases 222. The information stored in the databases 222 may include, for example user information, client information, details about bonds, and other information used by the marketplace control functionality 210.

As described above, marketplace control functionality 210 can provide an interface for creating and using a bond marketplace on a blockchain network 224 which is provided by a plurality of distributed nodes 226 that cooperate to create the blockchain. The blockchain network is able to execute smart contracts on nodes. Different smart controls are provided that interact to a smart contract bond marketplace 228. The smart contracts include a stablecoin smart contract 230 that provides the cryptocurrency for the bond marketplace. A whitelist smart contract 232 is used to provide permissions to entities interacting with the smart contract bond marketplace. For each bond issued, there is a bond token smart contract 234 and associated marketplace smart contract 236. The bond token smart contract tokenizes the bond and allows the bond tokens to be traded and the coupons automatically paid out to bond holders. The marketplace smart contract 236 provides a marketplace for placing bids and offers to buy and sell bonds. The bids and offers are made by bid smart contracts 238 and offer smart contracts 240 respectfully. Each marketplace smart contract 236 is created for each different bond. A global marketplace smart contract 242 can be provided to track all of the different bond marketplace smart contracts.

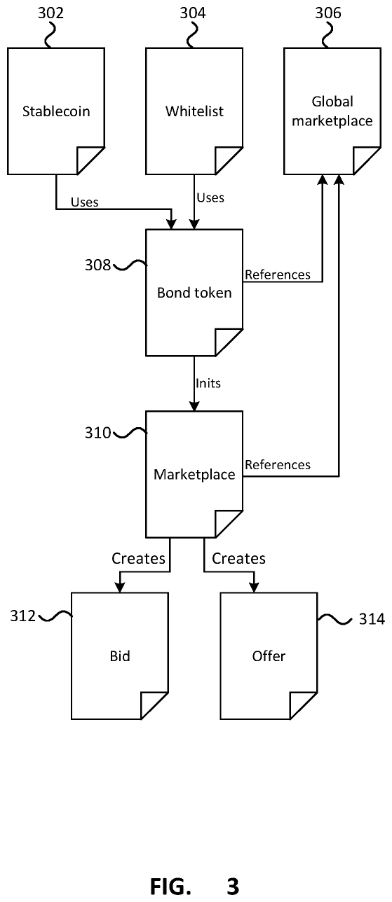

FIG. 3 depicts smart contract components that are implemented on a smart contract blockchain to provide a debt capital marketplace. The smart contracts, and the off-block functionality, work together to create a decentralized bond issuance and trading system. The backbone of the system is the BondToken smart contract 308 which mints tokens to represent bonds on the blockchain. The underlying currency used in the system is an ERC-20 stablecoin contract 302 although other coins may be used. A Whitelist contract 304 is used to track approved users and ensures permissions within the blockchain. A marketplace 310 contract is used to track and control the Bid contracts 312 & Offer contracts 314 that are associated with the Bond via the secondary market. Finally, a global market contract 306 is used to signal trades globally and offer a reference to each bond and its marketplace accordingly.

The whitelist contract 304 provides a global contract that can track whitelisted addresses. This will allow users to be accepted into the system and given the correct permissions for executing certain actions. Permissions may include for example market_maker, issuer and trader. This contract can be customized and tailored for different groups. It serves as the permissions for the system.

The stablecoin contract 302 provides a token to use as currency in the system. The stablecoin contract may be an implementation of the ERC-20 token and may be exchanged 1:1 for CAD or USD. Payments in the blockchain marketplace are made strictly using this coin. An exchange will offer a mint function where when a user pays with real money they receive stablecoin in exchange. If a user wishes to exchange for real money, the burn function will be used as the real currency leaves the system.

The bid contract 312 allows users to create a bid on the marketplace, meaning they want to buy X tokens at Y price. This contract is stored in the marketplace with an additional flag called closed. While closed is false, the trade will exist until it is matched, is cancelled or expires. When one of these options happens, its closed flag will be set to true. Users can specify a market or limit buy, which will execute based on the choice. Market: matching to equal, or Limit: matching to limit or better.

The offer contract 314 allows users to create an offer on the marketplace, meaning they want to sell X tokens at Y price. This contract is stored in the marketplace with an additional flag called closed. While closed is false, the trade will exist until it is matched, is cancelled or expires. When one of these options happens, its closed flag will be set to true. Users can specify a market or limit buy, which will execute based on the choice. Market: matching to equal, or Limit: matching to limit or better.

The GlobalMarketplace contract 306 serves to provide a global contract that can track all the different marketplaces initialized by their respected bond tokens. It will contain a mapping to map bond token contracts to their respected marketplace contracts. It will also contain an event EmitBondTraded that will trigger every time any bond is fully traded. This will allow for a view into the marketplaces as a whole, rather than each one separated.

The Marketplace contract 310 serves to provide a contract where secondary market trading of the bond can take place. It allows users to creates bids and offers and allows them to execute accordingly. Each marketplace function represents one bond's secondary market and is accessed through that contract's functions. Events are emitted to allow users to understand the pricing of secondary market and the bid/offer system is incorporated to create supply and demand. Staking per bid/offer can be implemented to prevent spam bids/offers. This holds funds and tokens until a trade has been executed or cancelled/expired. Cancelling may cost a user a fee, and if a trade expires there may be a full refund. A scan for expiry function may scan over bids and offers and close any that have lasted longer than the set time, time can be measured in blocks, (1 block=15 seconds). When a bid offer match is traded it will close both contracts in order to ensure no double trading. The marketplace is self-regulating and can trade based on user participants creating bids/offers, and removing based on time requirements.

The Bond Token contract 308 is the main component of the system. For every bond issued, there will be a corresponding token contract to represent it via the blockchain. Upon its initialization it will reference three contracts using the global stablecoin as currency, the global whitelist for permission, and creating its own marketplace contract for the use of the secondary market. Although described as generating its own marketplace contract, it is possible that the corresponding marketplace contract could be generated and deployed to the blockchain alongside the bond. The stablecoin and the whitelist are customizable allowing for different companies to plug in select features. The bond token will provide all the functions needed to interact with each of these contracts and allow the user to have a “one-stop-shop” for the contracts. Upon contract creation, the admin/issuer account will be in control of the bond tokens. Each user who buys a token is transferred a token in exchange for stablecoins and becomes a holder. Holders are then able to trade their tokens in the secondary market (marketplace) by creating offers and bids. These offer/bid contracts are stored in the market place and are used to create supply and demand for the bond tokens. Holders of bonds will be paid coupon payments based on set schedule and will receive final payment at the maturity date. This will be paid out based on (# of bond tokens*coupon)+(# of bond tokens*par value). This is all done automatically as a constant payment function is running that is checking the block time and bond payment schedule to see if it needs to execute the next payments. This takes a once fully manual process and moves it completely online. With block time, coupons can also be paid out as frequently as 15 seconds apart. The bond contract offers a one stop shop for access to all the additional contracts features, meaning a user only needs to interact with the bonds to be a part of the whole system.

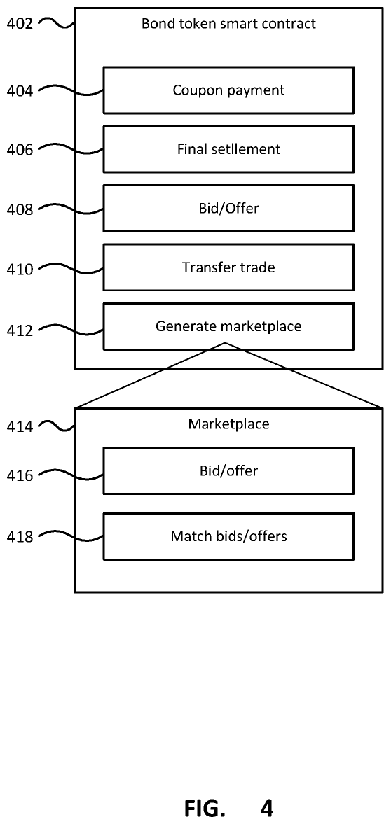

FIG. 4 depicts components of a bond token smart contract and a corresponding marketplace contract. The bond token contract 402 may include functions for coupon payment 404 that automatically transfers the coupon payment according to a coupon schedule. Final settlement function 406 may make a final payment of the bond to the bond holder upon the bond's maturity. A bid/offer function 408 allows bids and offers for the bond to be specified and a transfer trade function 410 can allow a bond token to be transferred. A generate marketplace function 412 may be used to initiate a marketplace contract 414 on the blockchain for the bond token. The marketplace contact may include bid/offer function 416 for receiving bids/offers for bonds and a match bids/offers function 418 that can match bids and offers and complete the transaction when a bid and offer matches. The matches between bids and offers may either be an exact match or partial match.

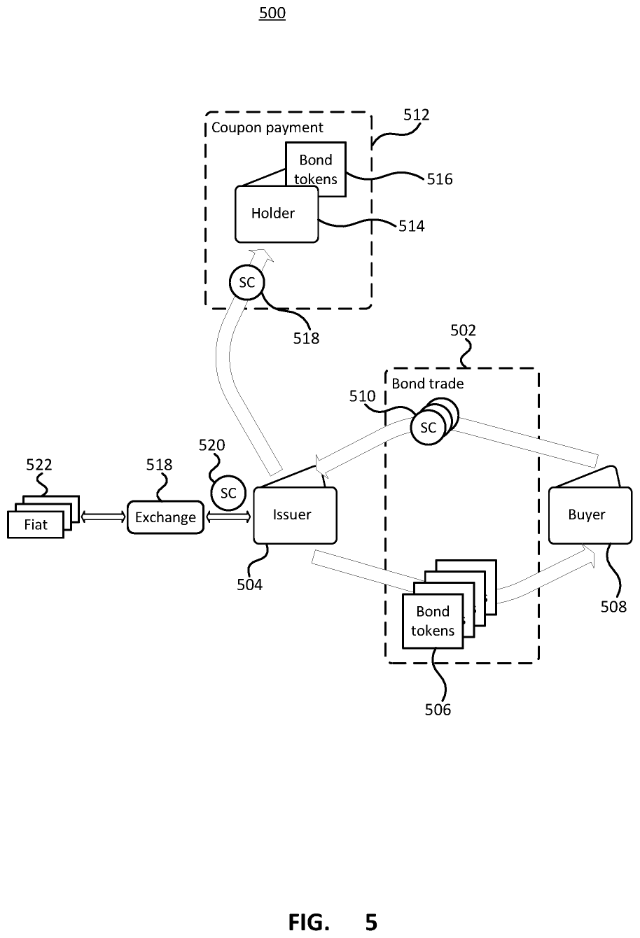

FIG. 5 depicts processes for purchasing and selling bonds as well as making coupon payments on a blockchain marketplace. A bond trade 502 allows an issuer 504, or bond holder, to transfer bond tokens 506 to a buyer 508 and transfers stablecoins 510 from the buyer to the issuer as payment. The results of the bond trade are stored on the blockchain so that the bond tokens are held by the buyer and the stablecoins are held by the issuer. A coupon payment process 512 occurs automatically to transfer the coupon payment as stablecoins 518 from the issuer 504 to the holder of the bond tokens 516. An exchange 518 allows stablecoin 520 to be exchanged for fiat currency 522 and vice versa.

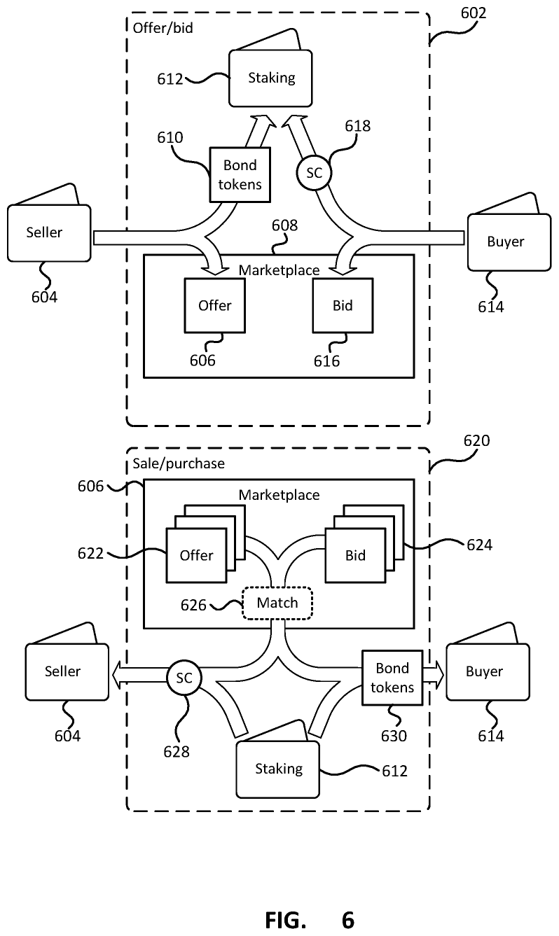

FIG. 6 depicts processes for creating offers for selling bonds and bids for purchasing them as well as completing the sale/purchase of bonds according to the offers and bids on the blockchain marketplace. Offers and bids 602 process may allow offers and bids to be generated. A seller 604 can create an offer 606 in the bond token's marketplace 608 to sell a certain number of bond tokens at a certain price. The offer may have additional conditions such as an expiry date/time. The bond tokens 610 of the offer 606 may be transferred to a staking wallet 612. A buyer may generate a bid 616 to buy a certain number of bond tokens at a certain price. The stablecoins for purchasing the bond tokens are transferred to the staking wallet 612. The bond tokens marketplace keeps track of the offers and bids and the bond tokens and stable coins for the offers/bids are held in the staking wallet until a trade transaction occurs.

A sale/purchase process is depicted 620. The market place 606 may have a number of offers 622 and bids 624 for selling and purchasing bond tokens. The sale/purchase may occur when a matching process 626 of the marketplace matches an offer with a bid. Once a match is made, the stablecoins 628 of the matched bid are transferred from the staking wallet to the seller 604 and the bond tokens of the matched offer are transferred from the staking wallet 612 to the buyer 614. Although not depicted in FIG. 6, the bond token's marketplace may include functionality for removing expired bids and offers as well as cancelling bids/offers.

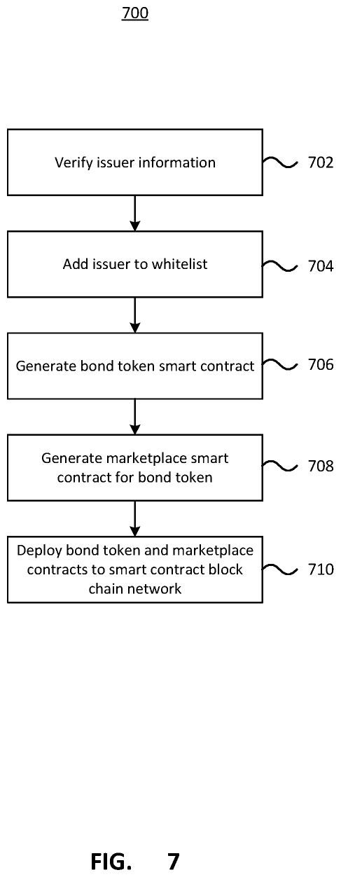

FIG. 7 depicts a method for issuing a bond on a smart contract blockchain. The method 700 may begin with verifying information of a bond issuer (702) and adding the issuer to a whitelist (704) on the blockchain that provides user permissions for the blockchain bond marketplace. It will be appreciated that if the issuer is already added to the whitelist they do not need to be added again and can simply be authenticated/authorized. Once the issuer is on the whitelist they are able to generate a bond token smart contract (706) corresponding to their bond. The bond token smart contract may be generated by specifying parameters for a pre-existing bond token template, or may be generated by writing the code of the smart contract or portions of the smart contact that are unique or specific to the bond. A bond marketplace smart contract for the bond token may be generated (708). The bond marketplace smart contract may be generated by functionality within the bond token smart contract so that the marketplace is deployed when the bond token is deployed to the smart contract. Alternatively, the marketplace smart contract may be generated separately from the bond token smart contract. Once the bond token smart contract and the marketplace smart contract are generated, with the marketplace smart contract possibly created within the bond token smart contract, the bond toke smart contract and marketplace smart contract are deployed to the smart contract blockchain network (710). Deploying the smart contracts to the blockchain makes the smart contracts and their functions available to others allowing the bond tokens to be traded.

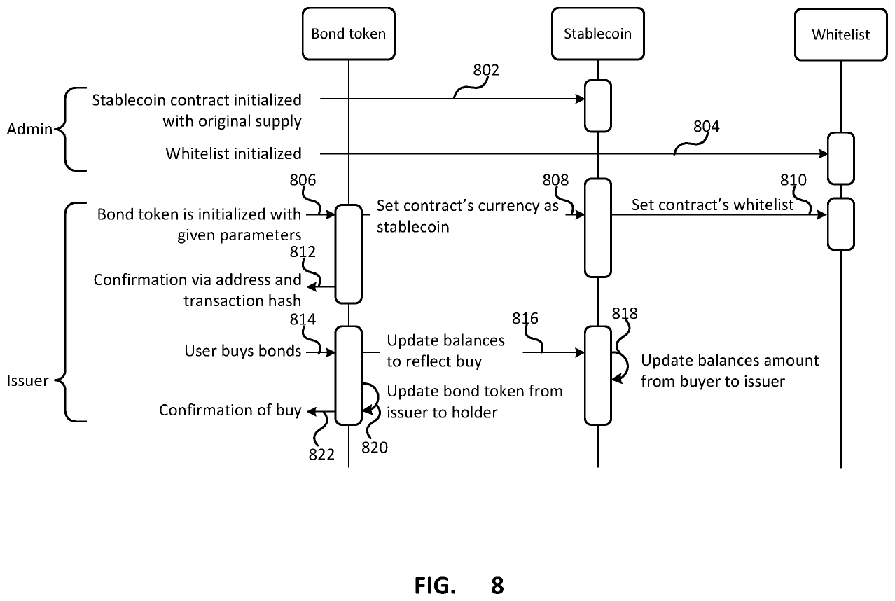

FIG. 8 depicts a process flow for bond issuance with a general primary market. An administrator initializes the stablecoin with an original supply (802) and initializes the whitelist (804). The admin may also initialize the global marketplace. An issuer generates or initializes a bond token with given parameters (806). The bond token may generate a corresponding bond marketplace. The bond token contract's currency is set to the stablecoin (808) and sets the contract's whitelist (810). Upon initialization of the bond token and setting the currency and whitelist, a confirmation may be provided to the issuer (812) by way of the bond token contract's blockchain address and transaction hash. A user may buy bonds (814) and the bond token may call a stablecoin function to update balances to reflect the buy (816) and the stablecoin balances are updated for the buy amount from the buyer to the issuer (818). The bond token being purchased is updated from the issuer to the holder (820) and the user gets confirmation of the buy.

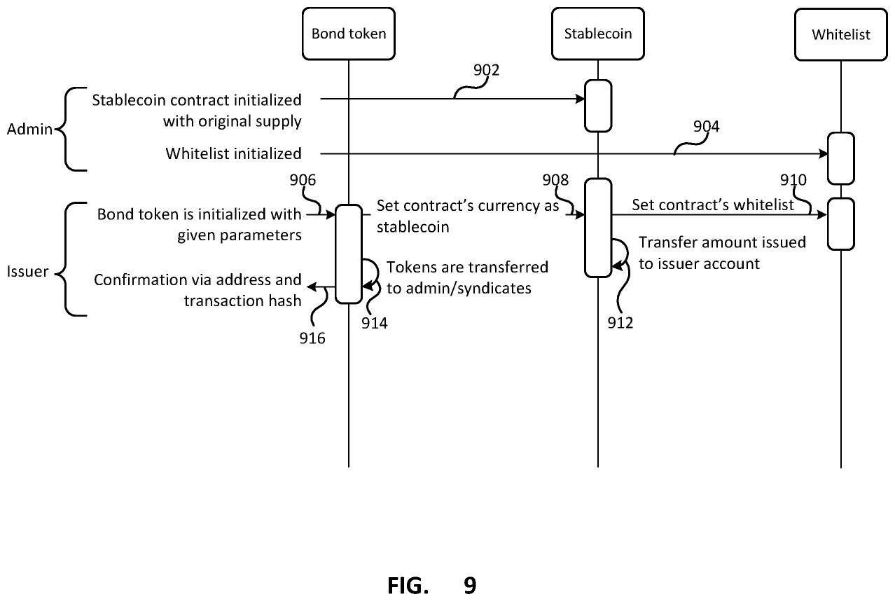

FIG. 9 depicts a process flow for regular bond issuance. An administrator initializes the stablecoin with an original supply (902) and initializes the whitelist (904). The admin may also initialize the global marketplace. An issuer generates or initializes a bond token with given parameters (906). The bond token may generate a corresponding bond marketplace. The bond token contract's currency is set to the stablecoin (908) and sets the contract's whitelist (910). The issued amount of stablecoins are transferred to the issuer account (912) and the bond tokens are transferred to an admin/syndicates (914) and confirmation provided by way of the bond token smart contract address and a transaction hash (916)

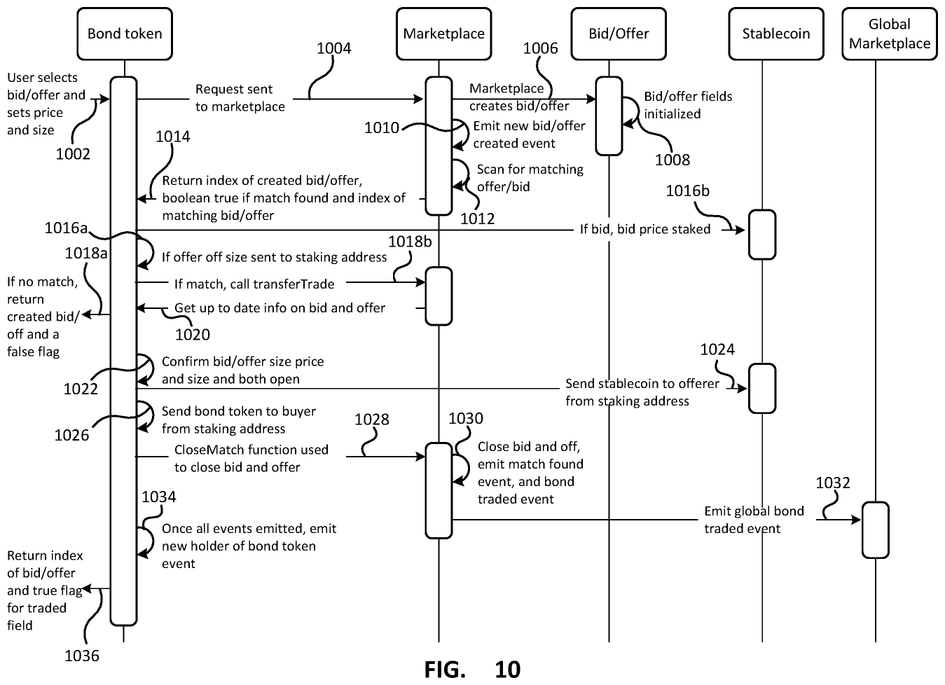

FIG. 10 depicts a process flow for bond trading with staking. A trader can select a bid or offer and sets the price and size (1002). The price may be done by letting a user add a premium or discount on the bond based on its current value (coupons left+par) which may be pre-calculated by the contract. The request is sent from the bond token to the marketplace (1004) which creates a corresponding bid or offer (1006). The bid/offer fields are initialized (1008) and the marketplace emits a new bid/offer created event (1010). The marketplace scans for any matching offers/bid using the price and size (1012) and returns the index of the created bid/offer and a Boolean of true if a match is found along with the index of the matching bid/offer (1014). If the trader created an offer, the offer size is sent from the offerer to staking address to hold the bond tokes until a trade occurs or the offer is cancelled (1016a). If the trader created a bid, the bid price is staked within the staking address to be held until traded or cancelled (1016b). If the match was found for the bid/offer an index of the created bid/offer and a false flag for traded is returned by the bond token (1018a). If a match was found, the transfer trade function of the bond token is called with the bid and offer indexes (1018b) and up-to-date information on the bid and offer are retrieved from the marketplace (1020) and the bid/offer information confirmed, for example the bid/offer price and size are equal and that the bid and offer are both open (1022). The stablecoin is then sent to the offerer from the staking address at the selected price per size (1024) and the bond tokes send to the buyer from the staking address (1026). A closeMatch function of the marketplace is used to finalize the trade and close the completed bid and offer (1028). The marketplace closes the bid and offer and emits a match found even and a bond traded event to signify the match and the trade occurring (1030). A global bond traded event may be emitted to let the entire global marketplace, rather than the bond's marketplace, to know of the trade (1032). The bond token may emit a new holder event to signify the exchange of the bond tokens (1034) and return to the user the index of the bid and offer and a true flag for the traded field signifying that trade went through (1036).

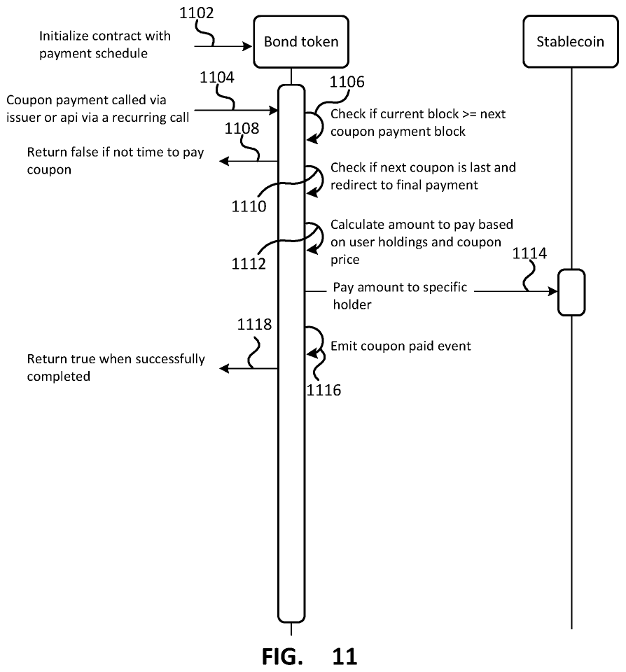

FIG. 11 depicts a process flow for coupon payment for bonds. When a contract is initialized, a payment schedule is created based on block time, marking the initial block of creation and the increment, in blocks, between payments, based on the coupon frequency and the length of the bond (1102). The coupon payment function of the bond token may be called via the issuer or API via a recurring call, occurring for example every minute-day (1104). When called the bond token checks if the current block is equal to or greater than the next block that coupon payment should happen on (1106) and will return false if it is not yet time to pay the coupons (1108). If it is time pay, it is determined if the next coupon is the last, and if it is the last coupon payment, payment can be redirected to the final payment (1110). The amount to pay is determined based on the user holdings and bond coupon price (1112) and the amount is payed to the bond holder (1114). A coupon paid event may be omitted to record payment for auditing and reconciliation (1116). Once successfully completed the bond token can return true (1118).

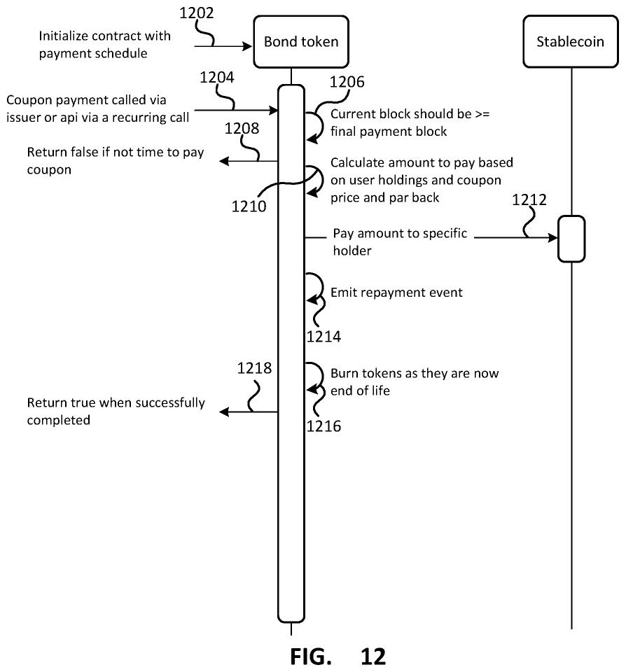

FIG. 12 depicts a process flow for final repayment of a bond. When a contract is initialized, a payment schedule is created based on block time, marking the initial block of creation and the increment, in blocks, between payments, based on the coupon frequency and the length of the bond (1202). The coupon payment function of the bond token may be called via the issuer or API via a recurring call, occurring for example every minute-day (1204). The current block should be equal to a greater than the final coupon block (1206) and will return false if it is not time for the final payout (1208). If it is time for the final payout, the amount to pay is calculated based on the user holdings and bond coupons price along with the added final payment of par for the bond (1210). The determined amount is paid to the specific holder (1212) and a repayment event is emitted (1214) to record the repayment for auditing and reconciliation. And bond tokens are burnt (1216) as they are now end of life and a true value is returned when successfully completed (1218).

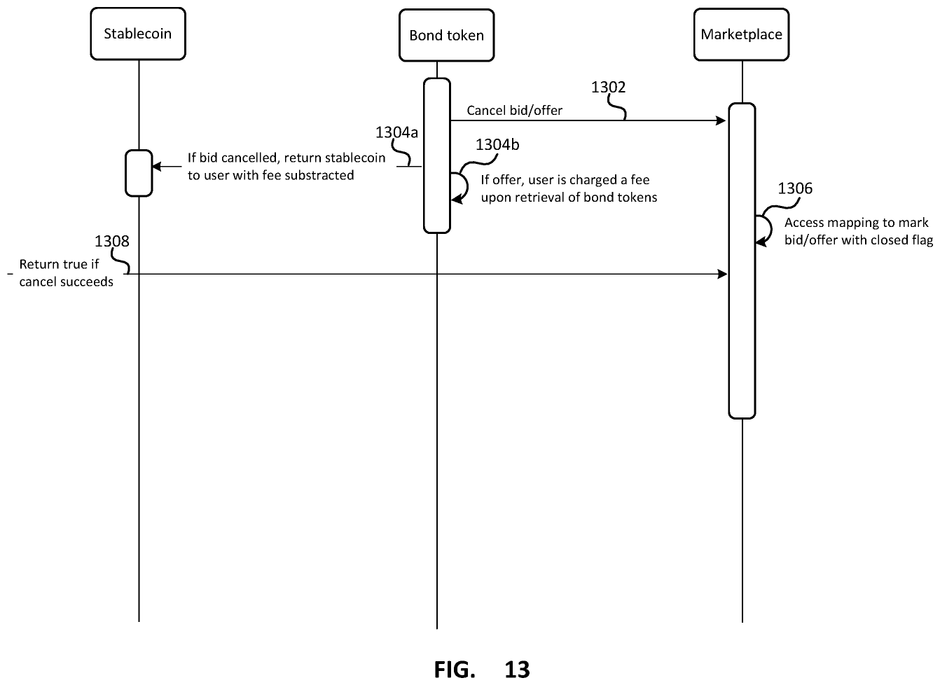

FIG. 13 depicts a process flow for cancelling a trade. A bid/offer can be cancelled by calling a cancel function (1302). If it is a bid being cancelled, the user receives the stablecoin back from a stake, possibly with a fee subtracted (1304a) and if it is an offer being cancelled the user is charged a fee upon retrieval of bond tokens (1304b). The mapping is accessed to mark the bid or offer with the closed flag (1306) and a true value is returned if the cancel succeeds (1308).

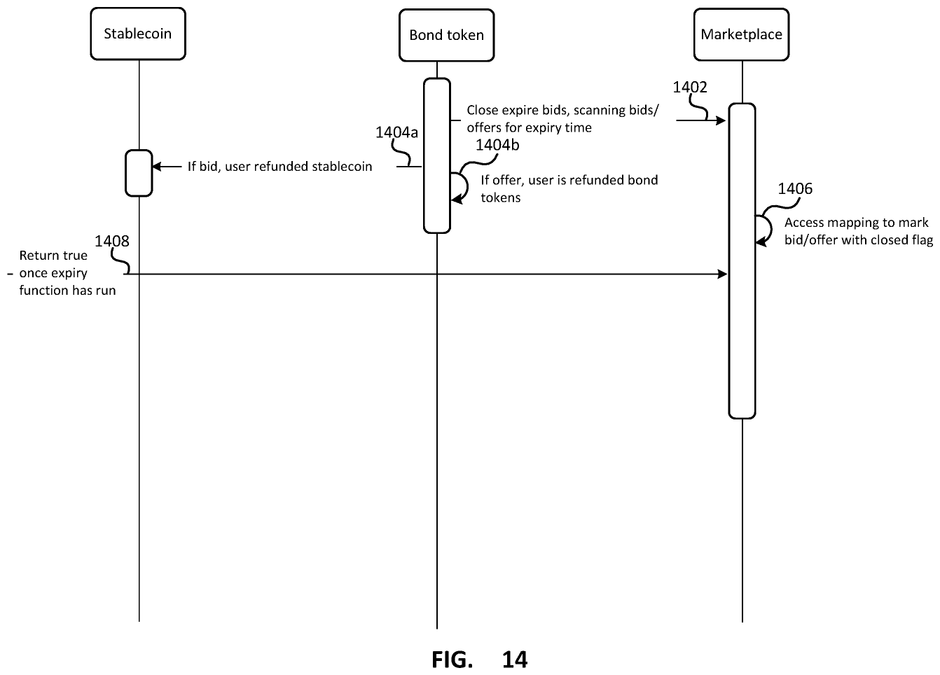

FIG. 14 depicts a process flow for an expiring trade. A close expired bids function may be called, which scans bids and offers from contracts past their expiry time (1402). If it is a bid that has expired, the used is refunded the stablecoin (1404a) and if it is an offer, the user is refunded the bond tokens (1404b). The expired bids and offers are marked with the closed flag (1406) and once the expiry function has run it returns true (1408).

The above has described systems/methods/processes for implementing a bond marketplace on a blockchain. In a specific embodiment the solution validates transactions on the Ethereum blockchain which reduces settlement cycle from the industry standard of two to three days to instant, real-time settlement. The system uses ERC-20 fungible tokens to fragment or fractionalize the minimum bond increment thereby reducing barriers for more diverse investors to participate in the bond market. For instance, the minimum bond increment for municipal bonds may be $5000 USD. The bond marketplace on the blockchain increases market transparency through a distributed and immutable ledger that allows regulators to see trading flows and identity of asset owners. While this benefits the entire market, this largely supports regulators by creating a single source of truth for enhanced auditing. This also supports regulators in implementing suitable policies for the market. The bond marketplace uses smart contracts to automate coupon payments. This solves a major pain point—the fact that the secondary market is very fragmented. It is a lengthy and arduous process to i) identify a bond that has been traded and thus changed ownership title and to ii) coordinate with paying agents to receive coupon payments. This not only maximizes the bondholder and issuer convenience but it also eliminates the need of a paying agent and thus, reducing industry standards of costs of issuance/trading. The smart contracts may be used to automatically fulfil outstanding bids/offers made by market participants. The distributed and immutable nature of blockchain technology as the backbone of the described solution creates an easily auditable and self-regulating market where the lifecycle of a bond and eventually other securities can exist as one source of truth. The transactions are append-only and thus, tamper-proof. Transactions are organized in chronological blocks of transactions that are linked together cryptographically. The accuracy and the order of transactions are safeguarded by a consensus algorithm running on all participant nodes of the blockchain network. The structure of the blockchain and transactions provides persistence of the transactions and data, security and integrity of data, coordination of transactions, trusted direct interaction among the network users, and the auditability, transparency and verifiability of network activities.

The current solution's blockchain backbone acts as the “one source of truth” which provides data integrity of financial transaction data, thereby reducing the existing need for data reconciliation in the securities issuance process. With the various intermediaries involved, there's ample room for human error, data recorded in silos, ultimately compromising data integrity, leading to the need for extensive cross-checking and reconciliation. The current solution's system architecture is designed with modularity and flexibility. Unlike other solutions with narrow use cases, the current solution is designed with the flexibility to introduce different assets & securities on the chain to be traded, tracked, audited, and more. Furthermore, the design of smart contracts allows developers to customize the business logic to easily integrate into a different bank's workflow. For instance, the whitelisting of participants may differ across different financial institutions. The current solution's smart contracts are flexible for other financial institutions, different types of issuers and investors. This creates the opportunity to create a consortium blockchain where syndicate banks and lead bookrunners can easily transact in one place efficiently.

The above has described a marketplace that may be implemented on a blockchain. The following listing provides example contracts for the Bond Token, Stable Coin, Marketplace, Global Marketplace and Whitelist contracts that may be used to implement such a marketplace on an Ethereum-based blockchain. It will be appreciated that the following is intended only as an example in various implementations are possible. The contracts are depicted using Solidity. It will be appreciated that other languages may be used for specifying the contracts.

While the above provides specific examples for implementing the particular smart contracts used by the blockchain based bond marketplace, it will be appreciated that the bond market may be implemented using various different smart contracts while still providing the functionality described above.

The processor used in the foregoing embodiments may comprise, for example, a processing unit (such as a processor, microprocessor, or programmable logic controller) or a microcontroller (which comprises both a processing unit and a non-transitory computer readable medium). Examples of computer readable media that are non-transitory include disc-based media such as CD-ROMs and DVDs, magnetic media such as hard drives and other forms of magnetic disk storage, semiconductor based media such as flash media, random access memory (including DRAM and SRAM), and read only memory. As an alternative to an implementation that relies on processor-executed computer program code, a hardware-based implementation may be used. For example, an application-specific integrated circuit (ASIC), field programmable gate array (FPGA), system-on-a-chip (SoC), or other suitable type of hardware implementation may be used as an alternative to or to supplement an implementation that relies primarily on a processor executing computer program code stored on a computer medium.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise (e.g., a reference in the claims to “a challenge” or “the challenge” does not exclude embodiments in which multiple challenges are used). It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections. The term “and/or” as used herein in conjunction with a list means any one or more items from that list. For example, “A, B, and/or C” means “any one or more of A, B, and C”.

It is contemplated that any part of any aspect or embodiment discussed in this specification can be implemented or combined with any part of any other aspect or embodiment discussed in this specification.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

What is claimed is:

1. A method for use in issuing a bond comprising:
adding an address of a verified bond issuer on a smart contract blockchain network to a whitelist smart contract (whitelist) executing on the smart contract blockchain network, the whitelist smart contract providing permissions for issuing and buying bonds on the smart contract blockchain network;
executing by the smart contract blockchain network a bond token smart contact for bond tokens, the bond tokens using a global stablecoin (stablecoin) defined in a global stablecoin smart contract as a currency, the bond token smart contract including functionality for:
specifying a coupon payment schedule;
paying coupon payments to blockchain addresses of respective bond token holders using the stablecoin, the coupon payments automatically paid according to the coupon payment schedule of the bond token; and
paying final payments to blockchain addresses of respective bond token holders using the stablecoin, upon maturity of the bond; and
executing by the smart contract blockchain network a marketplace smart contract for a bond marketplace, the marketplace smart contract including functionality for:
creating bids for purchasing bond tokens by authorized entities on the whitelist, the purchase made using the stablecoin;
creating offers for selling bond tokens by authorized entities on the whitelist, the sale made using the stablecoin; and
matching bids to offers to buy/sell bond tokens and carrying out the matched bids/offers.

2. The method of claim 1, further comprising:
periodically calling by the smart contract blockchain network the functionality for paying coupon payments of the bond tokens.

3. The method of claim 2, wherein the functionality for paying coupon payments determines if a current block of the smart contract blockchain network is greater than or equal to a block specified in the coupon payment schedule.

4. The method of claim 3, wherein the functionality for paying coupon payments calls the functionality for paying the final coupon payment when the current block of the smart contract blockchain network is greater than or equal to a final payment block specified in the coupon payment schedule.

5. The method of claim 1, wherein the functionality for creating bids comprises functionality for transferring the bid amount to a staking address until a transactions occurs for the created bid, the created bid is cancelled or the created bid expires.

6. The method of claim 1, wherein the functionality for creating offers comprises functionality for transferring the offer size of tokens to a staking address until a transactions occurs for the created offer, the created offer is cancelled or the created offer expires.

7. The method of claim 1, further comprising:
deploying a global marketplace contract to the smart contract blockchain network, the global marketplace contract comprising functionality for tracking different bond marketplace smart contracts.

8. A non transitory computer readable medium storing instructions for execution on a smart contract blockchain network, the instructions providing:
a whitelist smart contract providing permissions for entities for issuing, buying and selling bonds on the smart contract blockchain network;
a bond token smart contact for bond tokens for execution on the smart contract blockchain network using a stablecoin, the bond tokens including functionality for:
specifying a coupon payment schedule;
paying coupon payments to blockchain addresses of respective bond token holders using the stablecoin, the coupon payments automatically paid according to the coupon payment schedule of the bond token; and
paying final payments to blockchain addresses of respective bond token holders using the stablecoin, upon maturity of the bond; and
a marketplace smart contract (marketplace) for execution on the smart contract blockchain network, the marketplace including functionality for:
creating bids for purchasing bond tokens by authorized entities on the whitelist, the purchase made using the stablecoin;
creating offers for selling bond tokens by authorized entities on the whitelist, the sale made using the stablecoin; and
matching bids to offers to buy/sell bond tokens and carrying out the matched bids/offers.

9. The computer readable medium of claim 8, further comprising:
a stablecoin contract providing a stablecoin as a currency for buying and selling bond tokens on the smart contract blockchain network

10. The computer readable medium of claim 8, further comprising:
a bids smart contract for generating bids to purchase bond tokens; and
an offers smart contract for generating offers to sell bond tokens.

11. The computer readable medium of claim 8, wherein the functionality for paying coupon payments determines if a current block of the blockchain network is greater than or equal to a block specified in the coupon payment schedule.

12. The computer readable medium of claim 11, wherein the functionality for paying coupon payments calls the functionality for paying the final coupon payment when the current block of the blockchain network is greater than or equal to a final payment block specified in the coupon payment schedule.

13. The computer readable medium of claim 8, wherein the functionality for creating bids comprises functionality for transferring the bid amount to a staking address until a transactions occurs for the created bid, the created bid is cancelled or the created bid expires.

14. The computer readable medium of claim 8, wherein the functionality for creating offers comprises functionality for transferring the offer size of tokens to a staking address until a transactions occurs for the created offer, the created offer is cancelled or the created offer expires.

15. The computer readable medium of claim 8, further comprising:
a global marketplace contract to the smart contract blockchain network, the global marketplace contract comprising functionality for tracking different bond marketplace smart contracts.

16. A computing device for use in issuing a bond comprising:
a processor for executing instructions; and
a memory storing instructions which when executed by the processor configure the computing device to perform a method comprising:
accessing functionality executing on a smart contract blockchain network network to add an address on the smart contract blockchain network of a verified bond issuer to a whitelist smart contract (whitelist) executing on the smart contract blockchain network, the whitelist smart contract providing permissions for issuing and buying bonds on the smart contract blockchain network;
deploying to the smart contract blockchain network a bond token smart contact for bond tokens, the bond tokens using a global stablecoin (stablecoin) defined in a global stablecoin smart contract as a currency, the bond token smart contract including functionality for:
specifying a coupon payment schedule;
paying coupon payments to blockchain addresses of respective bond token holders using the stablecoin, the coupon payments automatically paid according to the coupon payment schedule of the bond token; and
paying final payments to blockchain addresses of respective bond token holders using the stablecoin, upon maturity of the bond; and
deploying to the smart contract blockchain network a marketplace smart contract for a bond marketplace, the marketplace smart contract including functionality for:
creating bids for purchasing bond tokens by authorized entities on the whitelist, the purchase made using the stablecoin;
creating offers for selling bond tokens by authorized entities on the whitelist, the sale made using the stablecoin; and
matching bids to offers to buy/sell bond tokens and carrying out the matched bids/offers.

17. The computing device of claim 16, further comprising deploying to the smart contract blockchain network a stablecoin contract providing a stablecoin as a currency for buying and selling bond tokens on the smart contract blockchain network

18. The computing device of claim 16, further comprising deploying to the smart contract blockchain network:
a bids smart contract for generating bids to purchase bond tokens; and
an offers smart contract for generating offers to sell bond tokens.

19. The computing device of claim 16, wherein the functionality for paying coupon payments determines if a current block of the blockchain network is greater than or equal to a block specified in the coupon payment schedule.

20. The computing device of claim 19, wherein the functionality for paying coupon payments calls the functionality for paying the final coupon payment when the current block of the blockchain network is greater than or equal to a final payment block specified in the coupon payment schedule.

21. The computing device of claim 16, wherein the functionality for creating bids comprises functionality for transferring the bid amount to a staking address until a transactions occurs for the created bid, the created bid is cancelled or the created bid expires.

22. The computing device of claim 16, wherein the functionality for creating offers comprises functionality for transferring the offer size of tokens to a staking address until a transactions occurs for the created offer, the created offer is cancelled or the created offer expires.

23. The computing device of claim 16 further comprising deploying to the smart contract blockchain network a global marketplace contract comprising functionality for tracking different bond marketplace smart contracts.
